(19) United States
(12) Patent Application Publication
(10) Pub. No.: US 2009/0019094 A1
(43) Pub. Date: Jan. 15, 2009

(54) REDIRECTED UPDATES ON A BACKUP SERVER

(76) Inventors: SCOTT DAVID LASHLEY, Portland, OR (US); Prasad Suresh Mujumdar, Fremont, CA (US); Clarence Madison Pruet, III, Flower Mound, TX (US)

Correspondence Address: PATTERSON & SHERIDAN, LLP/IBM SVL, 3040 POST OAK BLVD., SUITE 1500, HOUSTON, TX, 77056-6582, US

(21) Appl. No.: 11/777,776

(22) Filed: Jul. 13, 2007

(51) Int. Cl. G06F 17/30

(52) U.S. Cl. 707/203; 707/E17.007

(57) ABSTRACT

Embodiments of the invention relate to data processing systems and more specifically to high availability data processing systems comprising a primary server and a secondary server. The secondary server may receive an update request from a client. The secondary server may perform one or more preliminary operations required for processing of the update request. The secondary server may then redirect a partially processed update operation to the primary server for execution. Therefore, greater load balancing is achieved between the servers and more efficient utilization of secondary server resources is achieved.

### BACKGROUND OF THE INVENTION

1. Field of the Invention

The present invention is generally related to data processing systems and more specifically to high availability data processing systems.

2. Description of the Related Art

Large computer networks provide the necessary infrastructure for performing a variety of important functions. For example, today, databases and servers make it is possible to shop for basic consumer goods such as food and clothing over the internet by browsing websites illustrating product offerings from various vendors. As computer use becomes more pervasive, businesses offering products and services over a computer network face increasing data traffic accessing the servers configured to process consumer requests for the offered products and services. As a result, server failure or unavailability for unacceptably long periods of time may severely impact the profitability of a business.

Because availability of a computer system, for example, a server, may be crucial to customer satisfaction and profitability of a business, several solutions have been devised to increase the availability of servers and reduce the effects of system failure. One solution is to replicate the computer and storage systems to provide redundancy. For example, a primary server system may be configured to receive and process requests received over a network from multiple client systems. To process the requests, the primary server system may access a database located on the primary server system.

A copy of the database accessed by the primary server system may be maintained by a secondary server system. To maintain an accurate version of the database on the secondary computer system, the primary server system may be configured to communicate with the secondary server system so that the secondary server system performs the same sequence of operations performed by the primary server system. Therefore, if the primary server system fails, the secondary server system may continue to process requests without interrupting service. Although effective at providing a fault-tolerant redundancy for the primary system, the secondary system may essentially sit idle, waiting for the, often highly unlikely, event of primary system failure. Because the secondary system may be quite expensive to obtain and operate, this approach is frequently cost prohibitive.

In some cases, the secondary server may be configured to operate in read-only mode to service incoming database requests. This is useful for database operations skewed towards reading information from the database. A load-balancer may be used to distribute read-requests among the primary and secondary systems. In such a case, any operations involving modification of the database are performed only by the primary server. However, processing all update operations at the primary server may severely strain the primary server, create a performance bottleneck, and increase the probability of failure. Also, this approach requires a mechanism for the client to communicate with the load balancing regarding update operations. Frequently however, this is not possible as the load balancing application is simply not configured for this sort of communication. Further, requiring all update processing to be performed by the primary server may result in the primary server reaching its maximum processing capacity, thereby resulting in the inability to process one or more incoming requests. Still further, depending on the balance of read/write operations, the secondary system may remain substantially idle using this approach.

Accordingly, there remains a need for methods, systems, and articles of manufacture for processing requests received in a high availability data processing system having a primary server and secondary backup.

### SUMMARY OF THE INVENTION

One embodiment of the invention includes a computer-implemented method for updating a database. The method generally includes receiving an update request at a secondary database server. The the secondary database server provides a redundant failover for a primary database server. The method also includes performing one or more operations to partially process the update request at the secondary database server, where the operations performed at the secondary database server identify records that should be modified as a result of the update request. The method also includes generating, by the secondary database server, at least one partially processed update operation specifying one or more actions to be performed by the primary server to complete the update request and includes transmitting the partially processed update operation to the primary database server. The primary database server is configured to complete the partially processed update operation by modifying the identified records in the primary database server, as indicated by the partially processed update operation.

Another embodiment of the invention includes a computer program product comprising a computer readable storage medium having a computer readable program. The computer readable program when executed on a computer causes the computer to perform an operation for processing an update request received by a secondary database server. The operation may generally include receiving an update request at a secondary database server. The secondary database server provides a redundant failover for a primary database server. The operation may also include performing one or more operations to partially process the update request at the secondary database server, where the one or more operations performed at the secondary database server identify records that should be modified as a result of the update request. The operation may also include generating, by the secondary database server, at least one partially processed update operation specifying one or more actions to be performed by the primary server to complete the update request and transmitting the partially processed update operation to the primary database server. The primary database server is configured to complete the partially processed update operation by modifying the identified records in the primary database server, as indicated by the partially processed update operation.

Still another embodiment of the invention includes a system having a processor and a secondary database server program configured to provide a redundant failover for a primary database server. The database server program, when executed by the processor, performs an update operation that includes receiving an update request at a secondary database server. The the secondary database server provides a redundant failover for a primary database server. The update operation may also include performing one or more operations to partially process the update request at the secondary database server, where the one or more operations performed at the secondary database server identify records that should be modified as a result of the update request. The update operation may also include generating, by the secondary database server, at least one partially processed update operation which specifies one or more actions to be performed by the primary server to complete the update request and transmitting the partially processed update operation to the primary database server. The primary database server is configured to complete the partially processed update operation by modifying the identified records in the primary database server, as indicated by the partially processed update operation

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates exemplary communication between a primary server and a secondary server.

FIG. 3 illustrates another exemplary view of communication between a primary server and a secondary server.

FIG. 4 is a flow diagram of exemplary operations performed by a primary server and a secondary server during processing of client requests.

### DETAILED DESCRIPTION OF THE PREFERRED EMBODIMENTS

The present invention relates to data processing systems and more specifically to high availability data processing systems. A particular embodiment provides a redirected update mechanism for a secondary database system used to provide redundancy for a primary database system. In one embodiment, the secondary server may be configured to receive and process data request directly from a client. When an update request is received (i.e., an operation that requires data to be written to the database) the secondary server may perform one or more preliminary operations required for processing of the update request. The secondary server may then redirect a partially processed update operation to the primary server for execution. Therefore, greater load balancing is achieved between the servers as well as more efficient utilization of secondary server resources.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive and DVDs readable by a DVD player) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Exemplary System

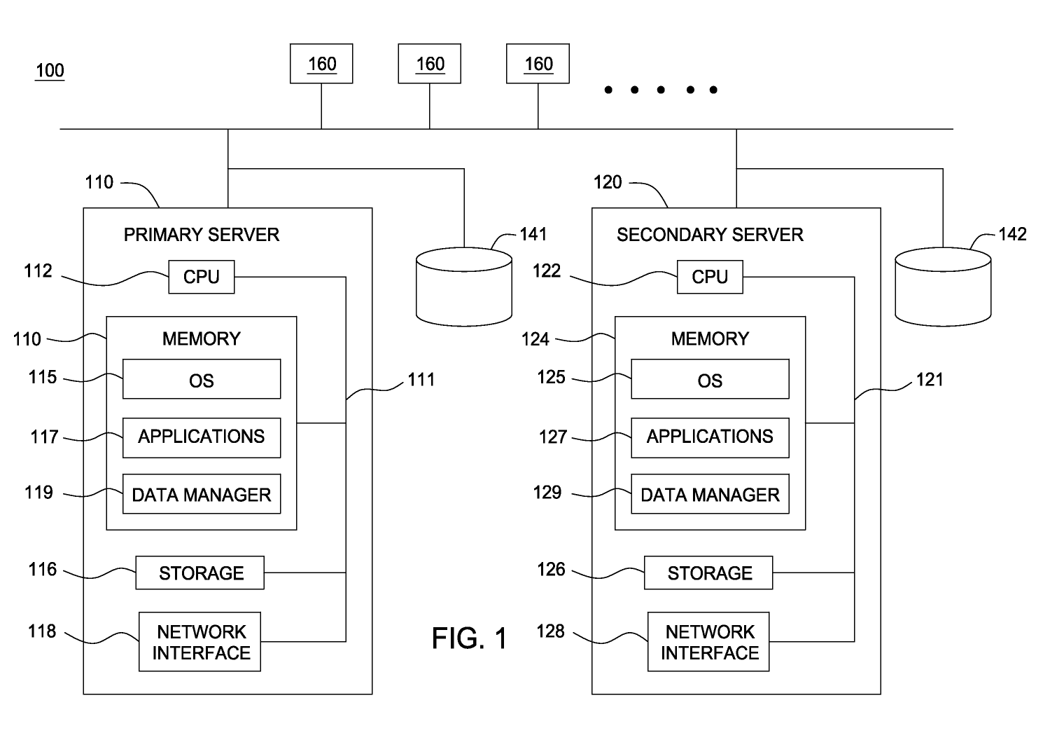

FIG. 1 illustrates an exemplary system 100 according to an embodiment of the invention. As shown, system 100 may include a primary server computer 110, a secondary server computer 120, and one or more client computers 160. The primary server computer 110, secondary server computer 120, and one or more client computers 160 are connected via a network 151. In general, the network 151 may be a local area network (LAN) and/or a wide area network (WAN). In a particular embodiment, the network 151 is the Internet.

Primary server computer 110 may include one or more central processing units (CPUs) connected via a bus 111 to a memory 114, local storage 116, and a network interface device 118. The network interface device 118 may be any device configured to allow network communications between the primary server 110 and any other device connected to network 151, for example, secondary server 120 and/or client computers 160.

Storage 116 may be a direct access storage device. Although it is shown as a single unit, storage 116 could be a combination of fixed and/or removable storage devices, such as fixed disc drives, floppy disc drives, tape drives, removable memory cards, or optical storage. The memory 114 and storage 116 could also be part of one virtual address space spanning multiple primary and secondary storage devices.

The memory 114 is preferably a random access memory sufficiently large to hold the necessary programming and data structures for an embodiment of the invention. While memory 114 is shown as a single entity, it being understood that memory 114 may comprise a plurality of modules and that memory 114 may exist at multiple levels, from high speed registers and caches to lower speed but larger DRAM chips.

Illustratively, memory 114 includes an operating system 115, applications 117, and a data manager program 119. Operating system 115 may be the i5/OS® available from IBM, a distribution of the Linux® operating system (Linux is a trademark of Linus Torvalds in the US and other countries) or a version of the Microsoft's Windows® operating system. More generally, any operating system supporting the functions disclosed herein may be used.

Applications 117 may be software products comprising a plurality of instructions that are resident at various times in various memory and storage devices in system 100. When read and executed by CPU 112, the applications 117 may cause the system 100 to perform the steps or elements embodying the various aspects of the invention. In one embodiment, a client computer 160 may be configured to issue requests for service to the primary server 110. The request may include, for example, a query to a database managed by the primary server 110. For example, the client computer 160 may use a graphical user interface (GUI) provided by an application program to create and issue requests to the primary server 110 and display data received from the primary server 110.

As described above, clients may submit requests to perform database operations to a database managed by the primary server 110. The database managed by the primary server 110 may be contained in a local storage device 116 and/or an external storage device 141 associated with the primary server 110. For example, in one embodiment, the database may be stored in the external storage device 141 and storage device 116 may serve as a cache to store a portion of the database associated with requests from a client computer 160. In such a case, the database application running on the primary server may pull pages from the database on storage 141 and store them locally in a cache in storage 116. Periodically, e.g., when the cache is full, or when a page is no longer needed, pages may be flushed back to storage 141. In one embodiment, storage 141 is a storage area network (SAN). As is known, a SAN provides network of storage disks and may be used to connect multiple servers (e.g., primary server 110 and clones 130) to a centralized pool of disk storage.

Data manager 119 may be a software application configured to communicate with secondary server 120. For example, data manager 119 may maintain a log file of all events that occur on primary server 110. Additionally, data manager 119 may transfer at least a portion of the log file to the secondary server 120 for processing. The log file may include a sequence of entries representing the actions performed by the database system running on primary server 110. By performing the same sequence of actions in the log, secondary server 120 maintains a ready backup state. Thus, if primary server 120 should fail, secondary server 120 may take over.

The secondary server 120 may be configured in a manner similar to primary server 110. Accordingly, secondary server 120 may include a CPU 122, memory 124, operating system 125, applications 127, data manager 129, storage 126, network interface 128, and the like, as illustrated in FIG. 1. In one embodiment, secondary server 120 may be configured to operate in a “recovery mode.” While in recovery mode, secondary server 120 performs the sequence of actions specified in log events written to a log file by the primary server 110. Additionally, while operating in recovery mode, secondary server 120 may be capable of processing client requests. For example, requests to read data may be processed by the secondary server 120.

A relatively tight relationship may be maintained between the primary server 110 and secondary server 120. For example, the primary server may transfer a log file comprising events that occur at the primary server 110 to the secondary server 120. The primary server 110 may periodically check on the status of log processing on the secondary server 120 to ensure synchronous processing. The primary server may determine whether the secondary server 120 has performed the actions specified in the most recent log entries. That is, the primary server may periodically determine whether the backend server needs to “catch-up” with the primary server 110. For example, in one embodiment, primary server 110 may set checkpoints in a log file to synchronize processing of a log file with the secondary server. Therefore, if the primary server becomes unavailable, the secondary server 120 may provide a backup system with a current state of the database.

Additionally, in one embodiment, secondary server 120 may be configured to perform some portions of a request that could potentially modify records in the database. For example, an operation to update records that meet some specified criteria may require substantial preliminary processing to identify which records, in fact, meet the specified criteria. In such a case, secondary server 120 may perform the preliminary operations, identify the records to update and then send a message to the primary system specifying which records to modify. In turn, the primary system may update the records and add entries to the log file reflecting the modification. Eventually, the secondary system will modify the same records as a result of processing log entries while operating in “recovery mode.”

Secondary server 120 may have at least the same amount of memory and a similar disk layout as primary server 110. For example, secondary server 120 may include a similar memory and storage capacity. Secondary server 120 may also have an associated external storage device 142 having at least the same amount of storage space as the external storage device 141.

As stated, the secondary server 120 may provide additional capacity for system 100 by processing requests to read a database maintained by the secondary server 120. Requests for data may be received and processed by the secondary server 120 to achieve load balancing between the database systems running on the primary server 110 and on the secondary server 120.

While some prior art systems allow secondary servers to operate in read-only mode to increase overall system utilization, the resources at the secondary server still remain largely under-utilized. For example, in prior art systems, all update requests are processed by the primary server, which can frequently become a substantial strain on the primary server. Embodiments of the invention provide a secondary server 120 capable of receiving update requests and performing at least a portion of the processing of the update requests to achieve load balancing and more efficient utilization of computing resources.

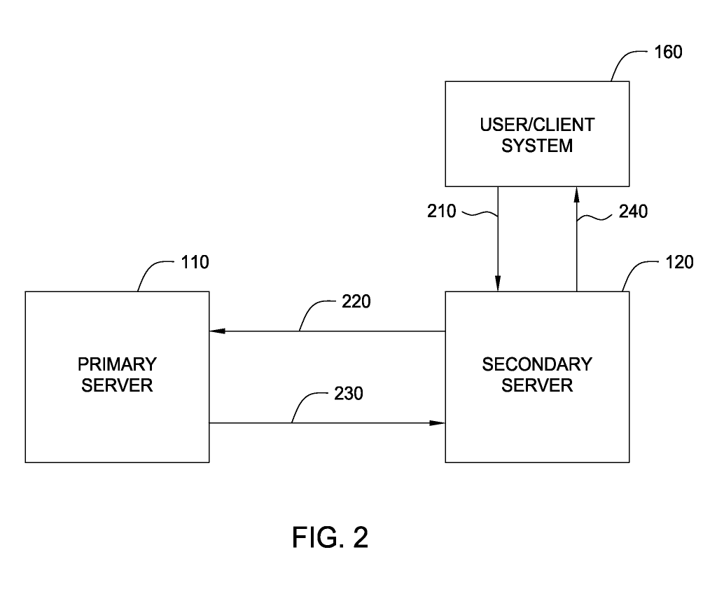

FIG. 2 illustrates communications between primary server 110 and secondary server 120 to perform both read and update requests, according to one embodiment of the invention. The communication between the primary server 110 and the secondary server 120 may be controlled by the data managers 119 and 129 (illustrated in FIG. 1) respectively. In one embodiment, client 160 may issue any number of read and/or update requests to the secondary server 160. For example, application 127 may allow the client 160 to request that secondary server 120 perform one or more operations on the copy of the database maintained at the secondary server 120. Alternatively, a load balancer (not shown) may distribute requests received from client 160 among primary server 110 and secondary server 120. In such a case, a round-robin or other scheduling protocol may be used to balance the workload of primary server 110 and secondary server 120.

The client 160 requests may include requests to retrieve data from the database. Accordingly, secondary server 120 may be configured to process the read request by performing a read access on, for example, storage device 126 and/or external storage device 142, to retrieve database contents. In a particular embodiment, secondary server 120 may include a web server running a web-based application. Client 160 may interact with the web server (using a web browser) to request contents from the database maintained at the secondary server 120. The data may include, for example, product offerings of a business which may be displayed in a web page at the client computer 160. Thus, the client 160 may initiate several read operations to browse through the product data contained in the database at the secondary server 120.

Further, embodiments of the invention allow secondary server 120 to receive and process at least a portion of an update request from the client computer 160. For example, during the use of the application 127, the client 160 may issue an update operation. Examples of update operations include requests to alter data in a database, deleting data, inserting data, modifying data, and the like. In the web server example described above, for example, the user may interact with a web browser on client 160 to select and purchase a product. Purchasing the product may require altering the database to store the client order, updating inventory numbers for the product, and the like.

In one embodiment of the invention, when an update operation is received (represented in FIG. 2 as arrow 210), secondary server 120 may perform at least a portion of the processing of the update request and redirect the actual write operation to the primary server 110. However, executing an update operation may involve performing a number of preliminary processing steps, for example, sorting data, selecting data to be modified, parsing, bundling, building an execution tree, retrieving the physical address of data, and the like, prior to performing a write access to update the database.

After performing the preliminary operations, secondary server 120 may determine a set of records to update in the database. To perform the actual update, rather than modifying data records in the database maintained at the secondary server, the secondary server may instead send a message to the primary server indicating which records to update in the database maintained at the primary server 110 (represented in FIG. 2 as arrow 220). The database session that processed the preliminary operations may block until it is confirmed that the update is completed at the primary server 110. Primary server 110 may receive the partially processed update operations and perform a write access to an associated database to complete the update operation. Because the bulk of processing the request remains with the secondary server, greater load balancing and greater overall system utilization may be achieved. Further, as the secondary server 120 may be operating in a recovery mode, it continues to process log entries received from the primary server 110 (represented in FIG. 2 as arrow 230). Once the log entries corresponding to the write operation redirected to the primary server is performed, the database server may send an acknowledgement to the client 160 indicating that the requested update operation has been completed (represented in FIG. 2 as arrow 240).

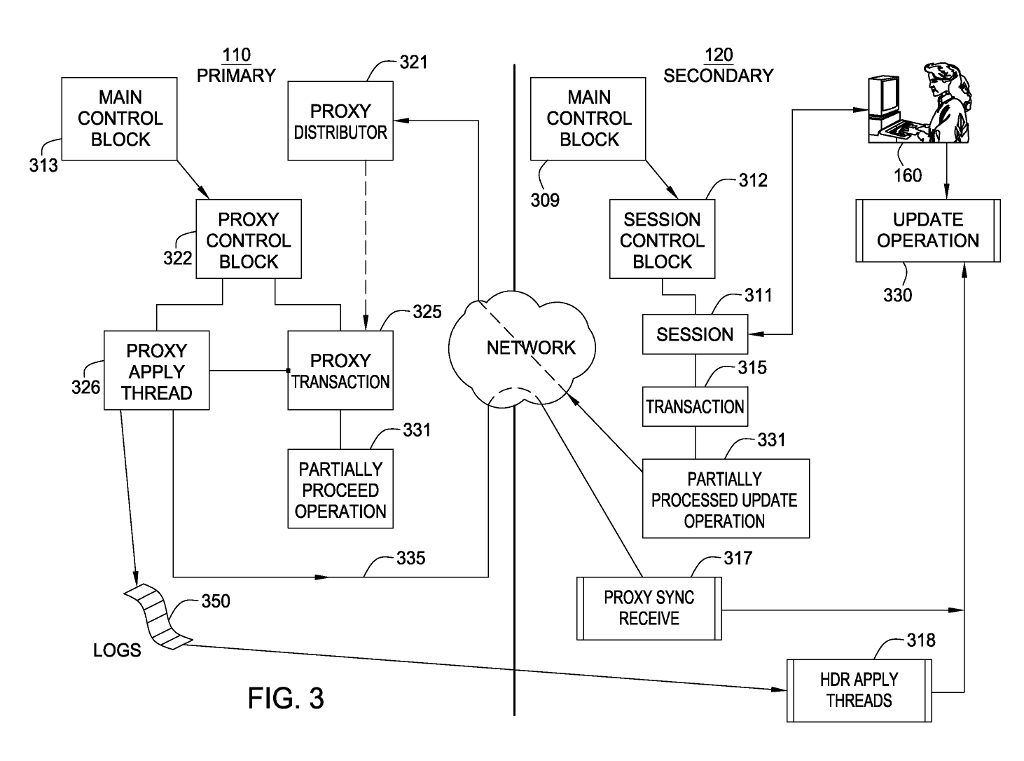

FIG. 3 illustrates a more detailed view of components of data managers 119 and 129 used to facilitate communications between primary server 110 and secondary server 120 when processing both read and update requests, according to one embodiment of the invention. As shown, a client 160 may send an update operation 330 to the secondary server 120. The update operation may include an operation structure 335. When update operation 330 is received, secondary server 120 may initiate a session with the primary server 110. For example, referring to FIG. 3, secondary server 120 may create a session 311 for the client 160. A session is generally used to manage a connection established with a database for any duration during which one or more database operations may be performed for a particular client. In one embodiment, the session 311 may be established to redirect update operations to the primary server 110. Redirection of update operations is discussed in greater detail below.

Also as shown, session 311 may be controlled by a session control block 312. Session control block 312 may manage a plurality of sessions 311 for a plurality of respective clients 160. Session control block 312 may be a part of (or pointed to by) a main kernel control block 309 of the secondary server 120. Main kernel control block 309 may be a part of the data manager 129 illustrated in FIG. 1. The main control block 309 on the secondary may include a master list of all sessions (on the secondary). Similarly, a main control block 313 on the primary may include a list of all redirected write operations (i.e., proxy control blocks 322)

In one embodiment, when an update operation is received, secondary server 120 may perform a search to identify any previously created session prior to creating a new session for the client 160. For example, it may be possible that a session 311 was already created for a client 160 during a previous operation requested by that particular client 160. If a session already exists, the same session 311 may be used to connect with the primary server 110.

As discussed above, secondary server 120 may be configured to redirect update operations to the primary server 110. Further, secondary server 120 may be configured to perform one or more preliminary processing steps to prepare data for writing by the primary server 110. The preliminary operations may include, for example, sorting data, selecting data to be modified, parsing, bundling, building an execution tree, retrieving the physical address of data, and the like. Performing the one or more preliminary operations may result in a partially processed update operation 331. Secondary server 120 may redirect the partially processed update operation 331 to the primary server 110, as illustrated in FIG. 3.

In one embodiment, the partially processed update operation transferred to the primary server 110 may include operation structure 335. Creating an operation structure 335 may involve performing the one or more of the preliminary operations described above. An operation structure 335 may contain the information necessary to complete the update operation. For example, in one embodiment, the operation structure 335 may include an optional before image, after image, operation, row identification, and the like for data. If the update operation is an insert operation, the before image may not be present. If the update operation is a delete operation, then the after image may not be present.

In one embodiment of the invention, the partially processed update operation 331 may be attached to a transaction 315 prior to redirecting the update operation to the primary server 110. A transaction 315 may identify a particular set of operations associated with a client 160. For example, in one embodiment, a client 160 may request all numerical entries in a table to be incremented by one if an identified condition is true. The client's request for the update may require multiple rows of the table to be updated, thereby requiring multiple update operations. The multiple update operations associated with the client request may be collectively part of the same transaction. A transaction value 315 may be assigned to the transaction and used to identify a given transaction as it is processed.

Furthermore, in the previous example, the one or more preliminary operations performed by the secondary server may include determining the particular rows to be incremented based on the condition. For example, the secondary server 120 may step through the rows of a table, determine the particular rows meeting the condition, determine a new value for fields of the row, and the like. The operation structure 335 may then be created for each row that requires an update and a partially processed update operation may be sent to the primary server 110 to update the row (2).

After the partially processed update operation 331 has been attached to a transaction 315 on the secondary server 120, the partially processed update operation 331 may be redirected to a distributor 321 on the primary server 110 via a network connection over, for example, network 151.

Once received, the distributor 321 may locate a transaction 325 which is being used to store the operations for the particular client 160. The partially processed update operation 331 may then be attached to the transaction 225 at the primary server 110. If a received partially processed update operation 331 is the first operation for a given transaction 225, then the distributor 321 may check to see if there is currently an inactive thread 326 available to process the transaction. If an inactive thread 326 is available, then the distributor 321 may wake that thread. However, if a sleeping thread is not found, then the distributor 321 may spawn a new thread 326.

In any case, in one embodiment, once active (or newly allocated), the thread 326 may be configured to write the partially processed update operation 331 into a log file 350. The thread 326 may then attach itself to transaction 325 and proceed to process update operations 331. If there are no pending partially processed update operations 331, then the apply thread 326 may sleep until the distributor 321 attaches another partially processed update operation 331 to the transaction 325.

The partially processed update operation 331 may be processed by the primary server 110 during normal log processing, thereby completing the update operation requested by the client 160. In one embodiment of the invention, when the update operation is completed by the primary server 110, the associated apply thread 326 may destroy the transaction structure 325 and place itself in a sleep queue until the next time that it is activated by the distributor 321.

In some cases, it may be necessary to synchronize operations performed at the primary server 110 and the secondary server 120. Accordingly, secondary server 120 may be configured to set synchronization points among with the operations redirected to the primary server 110. In this context, a synchronization point indicates that primary server 110 should send a message or acknowledgment to secondary server 120 when the synchronization point is reached by the primary server 110 while processing the operations. Such an acknowledgment indicates to secondary server 120 that primary server 110 has reached a certain point in processing re-directed writes. For example, secondary server 120 may wait after issuing a commit statement until an acknowledgment is received regarding a given set of operations redirected to primary server 110. Referring back to FIG. 2, in one embodiment, primary server 110 may be configured to send an acknowledgement to the secondary server 120 after reaching a synchronization point. (i.e., arrow 230). In a particular embodiment, secondary server 120 may set a checkpoint at the end of a particular transaction 315. After completing processing of operations associated with the transaction, primary server 110 may commit the updates associated with the transaction and send the acknowledgment to the secondary server 120. Secondary server 120 may stall normal operation until the acknowledgement is received. In other words, secondary server 120 may not process all or some of the incoming client requests until the acknowledgement is received for a particular transaction 315. For example, secondary server 120 may block processing of requests associated with data that is being modified.

As an example, a client 160 may issue a first update request configured to alter a first set of data to the secondary server 120. Secondary server 120 may perform one or more preliminary operations and transfer a partially processed update operation to the primary server 110. Subsequently, the client 160 may issue a read request to read the altered first set of data. However, the altered first set of data may not be reflected in the copy of the database contained in the secondary server 120. For example, the primary server may not have performed a write access to alter the first set of data or shipped a log file containing the partially processed update operation to the secondary server 120 for processing. Therefore, because incorrect data may be read, secondary server 120 may be configured to synchronize the update operation with the primary server 110.

Synchronizing with the primary server 110 may involve flagging a partially processed update operation as a synchronized operation, e.g., where the update operation is initiated at the secondary server 120. After a synchronized partially processed update operation is redirected to the primary server 110, incoming client requests may be blocked until an acknowledgment is received from the primary server 110. In other words, the secondary server 120 may be configured to stall all or some of the incoming client requests until the acknowledge signal 230 is received.

Accordingly, thread 326 may be configured to send an acknowledgement 335 to a sync receiver 317 at the secondary server 120. The acknowledgement 335 may be sent by apply thread 326 after the partially processed update operation is committed at the primary server 110. Client requests may be accepted after the acknowledgment 335 is received because a correct version of the first set of data is available, at least at the primary server 110. Alternatively, the apply thread 326 may place a ‘wakeup’ flag in the log records being placed in the log file 350 after processing a partially processed update operation that is flagged as a sync operation. As the incoming logs are processed by a thread 318 on the secondary server 120, incoming client requests may be unblocked. That is, the threads 318 perform the write operations reflected in log entries received from the primary server 110, as part of the recovery mode. As log entries corresponding to redirected writes are preformed, competed client requests may transition to an unblocked state.

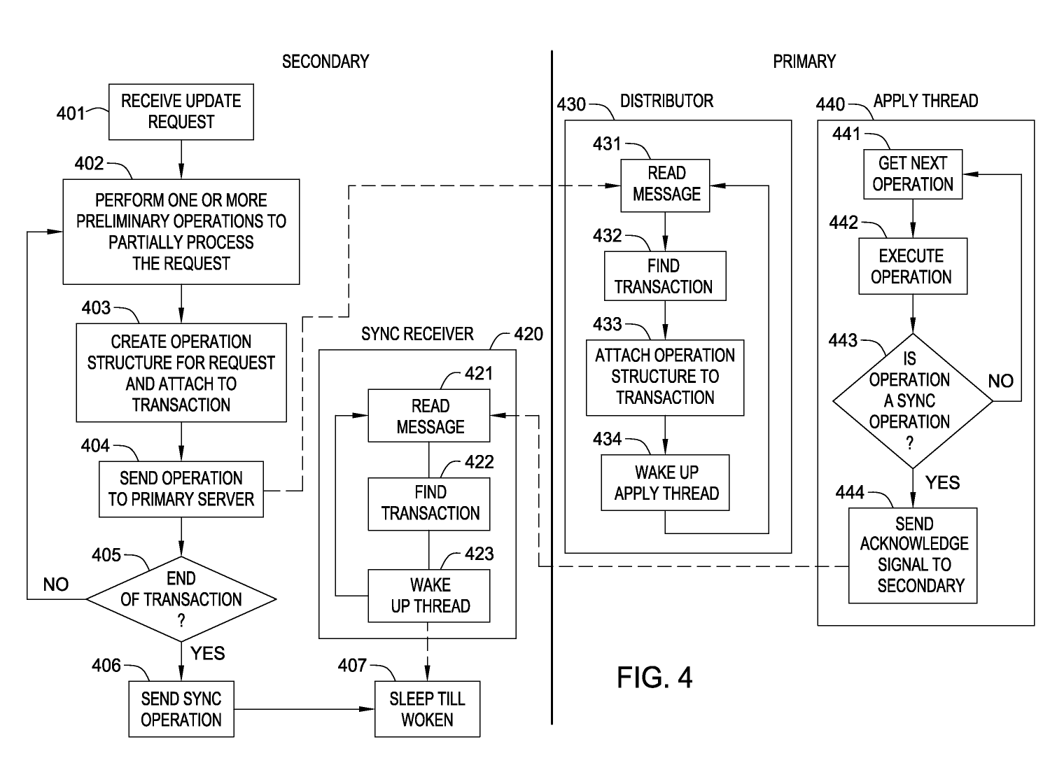

FIG. 4 is a flow diagram illustrating exemplary operations performed at the primary server 110 and secondary server 120 while processing update requests, according to an embodiment of the invention. The left side of FIG. 4 illustrates operations performed by the secondary server and the sync receiver 317 at the secondary server. The operations of the sync receiver are identified in box 420. The right side of FIG. 4 illustrates the operation of the distributor 321 (identified in box 430) and the thread 326 (identified in box 440).

As shown, the operations begin at step 401, where an update request is received by the secondary server 120. In one embodiment, the update request may require a plurality of update operations to be performed. For example, a plurality of rows may need to be updated based on the update request as described above. In response, secondary server 120 may perform one or more preliminary operations (step 402) to process the update request. For example, secondary server 120 may determine a particular row of a table that needs to be updated, the values to be inserted into the table, and the like. Other exemplary preliminary operations include sorting data, selecting data to be modified, parsing, bundling, building an execution tree, retrieving the physical address of data, and the like.

At step 403, secondary server 120 may create an operation structure for an update operation to be performed on primary server 110. For example, the secondary server may determine a before image and an after image of the data to be updated. At step 404, after completing the preliminary operations, secondary server 120 may redirect the partially processed update operation to the primary server 110.

At step 405, secondary server 120 may determine whether the last update operation sent to the primary server marks the end of a transaction. As discussed earlier, a transaction may be any set of update operations. If the current operation marks the end of a transaction, secondary server 120 may send a synchronization operation to the primary server (step 406). Alternatively, secondary server 120 may flag the last update operation as a synchronization operation prior to redirecting it to the primary server 110. Secondary server 120 may then block processing of all or a part of the client requests in step 407.

At step 405, if secondary server 120 determines that the current operation does not mark the end of the transaction, then secondary server 120 may select a next update operation and perform one or more preliminary operations to partially process the next update operation. At step 431, in one embodiment, distributor 321 receives the partially processed update operation from the secondary server 120 (sent in step 404). At step 432, in response to receiving an update operation, distributor 321 may identify a transaction associated with that update operation. In step 433, distributor 321 may attach the operation structure of the received update operation to the transaction. At step 434, distributor 321 may wake an apply thread 326.

At step 441, apply thread 326 may receive an update operation from the distributor 321. In response, at step 442, apply thread 326 may execute the update operation. Executing the update operation may involve performing a write access to update the database. At step 443, apply thread 326 may determine whether a received operation is a sync operation. If so, at step 444, apply thread 326 may send an acknowledgement 335 to the primary server. Alternatively, apply thread 326 may insert an indication in a log file to notify the secondary server 120 that the sync operation has been processed. If an operation is not determined to be a sync operation (step 443), apply thread 326 may retrieve a next operation for processing at step 441.

At step 421, the acknowledgement sent by apply thread 326 may be received by a sync receiver 317 at the secondary server. At step 422, sync receiver 317 may identify a transaction associated with the received acknowledge signal. And at step 423, sync receiver may wake a dormant client thread, allowing the secondary server 120 to receive and process new client requests that were blocked (step 407).

In some cases, an update operation redirected from a secondary server may attempt to update an incorrect version of data. For example, an update operation may be configured to update a first version of a row in a table to a second version of the row. However, it may be possible that the primary server has already updated the row at the primary server. Therefore, the update operation sent from the secondary server may incorrectly update the row. In one embodiment, primary server 110 may compare the previous image of the row (included in the operation structure) with the current version of the row at the primary server prior to executing an update operation. If the previous image is the same as the current version, then it may be determined that the secondary server 120 is attempting to update the correct version of the row. If, however, the previous image is not the same as the current row, then the update operation may not be performed and an error message may be generated to the secondary server.

In one embodiment, row versioning may be implemented to reduce network traffic. In systems implementing row versioning, each row may have an associated version number. If a row is updated, the row version may be incremented by a predetermined value, for example, by one. Therefore, secondary server 120 may simply send the current image of data along with the version number of the row it is attempting to update. By comparing the version number received to the version number of the current row, primary server may be able to determine whether the update operation is proper.

Advantageously, by allowing the secondary server to perform at least a portion of the processing of an update operation and redirecting the partially processed update operation to a primary server to complete processing of the update operation, embodiments of the invention achieve greater load balancing and more efficient utilization of resources available at the secondary server. Therefore, the likelihood of system failure is decreased and performance is enhanced.

While the foregoing is directed to embodiments of the present invention, other and further embodiments of the invention may be devised without departing from the basic scope thereof, and the scope thereof is determined by the claims that follow.

What is claimed is:

1. A computer-implemented method for updating a database, comprising:
receiving an update request at a secondary database server, wherein the secondary database server provides a redundant failover for a primary database server;
performing one or more operations to partially process the update request at the secondary database server, wherein the one or more operations performed at the secondary database server identify records that should be modified as a result of the update request;
generating, by the secondary database server, at least one partially processed update operation specifying one or more actions to be performed by the primary server to complete the update request; and
transmitting the partially processed update operation to the primary database server, wherein the primary database server is configured to complete the partially processed update operation by modifying the identified records in the primary database server, as indicated by the partially processed update operation.

2. The method of claim 1, wherein the one or more operations include scanning one or more rows of a table in the database to identify which of the one or more rows of the database maintained by the secondary database server to update in response to the update request.

3. The method of claim 1, further comprising:
recording, by the primary database server, an indication of the update operations performed at the primary database server in a log file; and
transmitting at least a portion of the log file that includes the recorded operations to the secondary database server, wherein the secondary database server is configured to perform the operations recorded in the log file.

4. The method of claim 1, wherein the one or more operations performed by the secondary database server include any combination of:
scanning data;
sorting data;
parsing data;
selecting data; and
building an execution tree for executing the update operation.

5. The method of claim 1, wherein the one or more operations performed by the secondary database server include generating an operation structure comprising at least an image of data that is to be modified.

6. The method of claim 5, wherein the operation structure further comprises a previous image of data that is to be modified.

7. The method of claim 6, further comprising:
comparing, by the primary database server, the previous image of data to current data at the primary database server; and
executing the update operation if the previous image of data provided by the secondary database server is the same as current data at the primary database server.

8. The method of claim 5, wherein the operation structure includes a version number for each row of data in the primary database server to be modified.

9. The method of claim 8, further comprising:
comparing, by the primary database server, the version number in the operation structure with a corresponding version number for each row of data in the primary database server to be modified; and
completing the update operation only if the version number in the operation structure is the same as the corresponding version number the primary database server.

10. The method of claim 1, further comprising:
blocking incoming database access requests by the secondary database server after a first set of update operations are sent to the primary database server;
sending, by the primary database server, an acknowledgement to the secondary database server after completing execution of the first set of update operations; and
in response to receiving the acknowledgment, unblocking incoming database access requests by the secondary database server.

11. A computer program product comprising a computer-useable storage medium having a computer readable program, wherein the computer readable program when executed on a computer causes the computer to perform an operation for processing an update request received by a secondary database server, the operation comprising:
receiving an update request at a secondary database server, wherein the secondary database server provides a redundant failover for a primary database server;
performing one or more operations to partially process the update request at the secondary database server, wherein the one or more operations performed at the secondary database server identify records that should be modified as a result of the update request;
generating, by the secondary database server, at least one partially processed update operation specifying one or more actions to be performed by the primary server to complete the update request; and
transmitting the partially processed update operation to the primary database server, wherein the primary database server is configured to complete the partially processed update operation by modifying the identified records in the primary database server, as indicated by the partially processed update operation.

12. The computer-useable storage of claim 11, wherein the one or more operations include scanning one or more rows of a table in the database to identify which of the one or more rows of the database maintained by the secondary database server to update in response to the update request.

13. The computer-useable storage medium of claim 11, wherein the primary database server is configured to:
record an indication of the update operations performed at the primary database server in a log file; and
transmit at least a portion of the log file that includes the recorded operations to the secondary database server, wherein the secondary database server is configured to perform the operations recorded in the log file.

14. The computer-useable storage medium of claim 11, wherein the one or more operations performed by the secondary database server include any combination of:
scanning data;
sorting data;
parsing data;
selecting data; and
building an execution tree for executing the update operation.

15. The computer-useable storage medium of claim 11, wherein the one or more operations performed by the secondary database server include generating an operation structure that includes at least an image of data that is to be modified.

16. The computer-useable storage medium of claim 15, wherein the operation structure further includes a previous image of data that is to be modified.

17. The computer-useable storage medium of claim 16, wherein the operations further comprise:
comparing, by the primary database server, the previous image of data to current data at the primary database server; and
executing the update operation if the previous image of data provided by the secondary database server is the same as current data at the primary database server.

18. The computer-useable storage medium of claim 15, wherein the operation structure includes a version number for each row of data in the primary database server to be modified.

19. The computer-useable storage medium of claim 18, wherein the operations further comprise:
comparing, by the primary database server, the version number in the operation structure with a corresponding version number for each row of data in the primary database server to be modified; and
completing the update operation only if the version number in the operation structure is the same as the corresponding version number the primary database server.

20. The computer-useable storage medium of claim 11, wherein the operations further comprise:
blocking incoming database access requests by the secondary database server after a first set of update operations are sent to the primary database server;
sending, by the primary database server, an acknowledgement to the secondary database server after completing execution of the first set of update operations; and
in response to receiving the acknowledgment, unblocking incoming database access requests by the secondary database server.

21. A system, comprising:
a processor; and
a secondary database server program configured to provide a redundant failover for a primary database server, and wherein the program, when executed by the processor, is configured to process an update operation by performing the steps of:
receiving an update request at a secondary database server, wherein the secondary database server provides a redundant failover for a primary database server,
performing one or more operations to partially process the update request at the secondary database server, wherein the one or more operations performed at the secondary database server identify records that should be modified as a result of the update request,
generating, by the secondary database server, at least one partially processed update operation specifying one or more actions to be performed by the primary server to complete the update request, and
transmitting the partially processed update operation to the primary database server, wherein the primary database server is configured to complete the partially processed update operation by modifying the identified records in the primary database server, as indicated by the partially processed update operation.

22. The system of claim 21, wherein the one or more operations include scanning one or more rows of a table in the database to identify which of the one or more rows of the database maintained by the secondary database server to update in response to the update request.

23. The system of claim 21, wherein the primary database server is configured to perform the steps of:
recording, by the primary database server, an indication of the update operations performed at the primary database server in a log file; and
transmitting at least a portion of the log file that includes the recorded operations to the secondary database server, wherein the secondary database server is configured to perform the operations recorded in the log file.

24. The system medium of claim 21, wherein the one or more operations performed by the secondary database server include any combination of:
scanning data;
sorting data;
parsing data;
selecting data; and
building an execution tree for executing the update operation.
